(19) United States
(12) Patent Application Publication
(10) Pub. No.: US 2006/0040835 A1
(43) Pub. Date: Feb. 23, 2006

(54) Cleansing system and method

(76) Inventors: R. Scott Newkirk, Sun City, AZ (US); Douglas W. Gilmore, Cave Creek, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/208,196

(22) Filed: Aug. 19, 2005

Related U.S. Application Data
(60) Provisional application No. 60/603,063, filed on Aug. 19, 2004.
(60) Provisional application No. 60/688,561, filed on Jun. 8, 2005.

(51) Int. Cl. C11D 17/00

(52) U.S. Cl. 510/127

(57) ABSTRACT

An exemplary system and method for providing a handwash composition that changes color after a substantially predetermined period of time is disclosed as comprising colorant particles suspended in a surfactant solution. The colorant particles are configured to rupture after a given amount of time of exposure to shear forces resulting from the mechanical agitation of the surfactant to produce a lather. Upon rupture (or alternatively, adequate abrasion) of the colorant particles, the user observes that the soap lather has changed color—thus indicating that a sufficient amount of time has elapsed and that the hand washing activity has likely achieved its intended purpose.

### RELATED APPLICATIONS

This application claims priority to: U.S. Provisional Patent Application Ser. No. 60/603,063 filed in the U.S. Patent and Trademark Office on Aug. 19, 2004 by R. Scott Newkirk; and U.S. Provisional Patent Application Ser. No. 60/688,561 filed in the U.S. Patent and Trademark Office on Jun. 05, 2005 by D. Gilmore and R. Scott Newkirk.

### FIELD OF INVENTION

The present invention generally concerns cleansers (for example, detergents, soaps, shampoos, and the like). More particularly, the present invention involves an exemplary system and method for the delayed release of microencapsulated colorants and fragrances in cleanser products.

### BACKGROUND

Cleansing compositions utilizing various surfactants are known in the art. In general, the user introduces portions of the cleanser to the applied area developing a lather with water, for example. The lather may be subsequently removed by rinsing with water or, in the case of a liquid cleanser, additional cleansing composition. The cleansing action of the surfactant in such compositions may not always be ideally realized if the duration of lathering or application of the cleanser has not occurred and continued for a particular period of time. For example, some States provide regulations requiring restaurant workers to periodically wash their hands for a minimum period of time - in seeming appreciation of an optimal duration for which the worker's hands must remain in contact with the cleanser before the worker's hands may be regarded as “clean”.

### SUMMARY OF THE INVENTION

In accordance with various representative aspects of the present invention, a soap composition is disclosed which may be dispensed, for example, onto the hands of a user for washing. The user may then be instructed to lather the soap and continue scrubbing until a color change occurs and/or the color dissipates. In certain representative applications, the color change may take up to about 15 seconds to about more than 1 minute, thereby giving the user an appropriate amount of time to properly cleanse their hands. The color may be adapted to dissipate due to exposure to air, exposure to water, the lapsing of a given amount of time, exposure to ultraviolet light, and/or the like. The color change may embody a broad range of colors that may be keyed to specific uses, applications and/or operating environments. The colorant may be employed with a broad range of soaps, including, for example: liquid soaps, semi-soft soaps, powdered soaps, pressed-bar soaps, and/or the like.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a system and method for changing the color of liquid hand soap lather upon application of mechanical forces over a generally predetermined period of time, is provided as a specific enabling disclosure that may be readily generalized to any application of the disclosed system and method for encapsulating materials in cleansing products.

An exemplary embodiment of the present invention comprises a liquid hand soap wherein the time duration of hand washing may be indicated by a color change. For example, a microcapsule (or visible bead) containing a cosmetically-suitable dye may be incorporated into a liquid soap composition such that vigorous washing over a given period of time mechanically degrades the microcapsules to release a colorant indicative of the passage of time corresponding to mechanical lathering of the soap. The physical properties of the encapsulating material may be adjusted to achieve a suitably adapted timing of release of the colorant.

Several products are conceived for various commercial and industrial settings, as well as novelty products for children and/or other consumers. Other market segments may include institutional customers, hospital workers, pediatricians, cold/flu season retail products, etc.

The system may be passive or active. For example, in a passive system, the colorant may be release in correspondence with the shear force of lathering the soap. Accordingly, for example, a green-tinted capsule may break, thereby releasing a green colorant changing the color of foam on the user's hands from white to green. It will be appreciated that the integrity of the dye capsule may be a criteria for maintaining the white (e.g., non-colored) appearance of the soap lather until the colorant is released.

In an active system, the released colorant may be suitably configured to undergo a chemical transformation contributing to the color change. For example, a soap product may comprise an encapsulated pH-indicator dye that changes color when released (e.g., by shear forces) into a weakly alkaline hand soap. One potential advantage of an active system over that of a passive system is the ability to produce a rather abrupt color change, while passive systems are more likely to yield a gradual color change.

Another exemplary design criterion may include the ability of the colorant capsules to withstand dispensing from the product package. In an representative embodiment of the present invention, Primasphere microcapsules (available from Cognis Corp., Cincinnati, USA) encapsulated with chitosan may be employed. The chitosan coverage may be adapted to be sufficiently high to ensure capsule integrity and that the capsules are resistant (but generally not impervious) to shear forces. In a representative application and exemplary embodiment, the chitosan coverage may be suitably adapted to alter the timing of release of the colorant for a given lathering shear force. After microencapsulation of the colorant, the microcapsule may be gently rinsed to remove any non-encapsulated indicator dye.

In an exemplary embodiment, microcapsules may be formed to encapsulate a phenolphthalein solution in Primaspheres with a suitable solvent. If formed in a liquid hand soap with a pH of about 9.5, breakage of the microcapsules during lathering would cause a color change from white to pink. Another advantage of using a relatively high pH indicator to trigger a color change is that the pH will return to neutral (e.g., about 7.0) during rinsing with water, which would turn the indicator clear again. It will be appreciated that any type of indicator, whether now known or otherwise hereafter described in the art, may be employed to achieve a substantially similar result.

A representative formulation of a generally opaque soap product in accordance with an exemplary embodiment of the present invention may include the following to produce approximately 260 gallons (˜2172 lbs.) of soap: 1,650.60 lbs. water; 340 lbs. sodium lauryl sulfate; 140 lbs. cocoamide DEA ninol 40-CO; 15 lbs. SEG chips ethylene glycol mon; 5 lbs. methylparaben; 5 lbs. propylparaben; 5 lbs. Glydent; 0.63 lbs. vitamin E; 4 lbs. AFF#24465; 3.5 lbs. Hampeen 100 EDTA; 3.25 lbs. phosphoric acid; and 10.8 lbs. microencapsulated colorant beads.

Such a formulation may be realized in accordance with the following representative manufacturing procedure: hot water spray clean large stainless steel jacketed tank; disinfect tank, hoses, pumps, equipment, containers and general area; heat and fill tank with deionized water; at heating of about 80 degrees Celsius, add sodium lauryl sulfate while running propeller (hold 8 lbs. SLS for last step of thickening batch); mix in SEG chips, methylparaben and pour into batch; bring water to within 10 inches of top of vessel rim and heat to 80 degrees Celsius; begin cooling to 40 degrees Celsius; at 40 degrees Celsius, add Glydent, 56 oz. of Hampeen, 10,068 oz. of phosphoric acid 85% plus mix fragrance and 8 oz. Vitamin E into separate pail of 15 lbs. cocoamide DEA; add remainder of cocoamide to the batch; continuing slow mix with addition of remainder of water to within 1 inch of top of vessel; mix 10 lbs. of water with 2 lbs. of fine table salt and add salt/water mixture to thicken batch; check pH for 6.8; add diluted phosphoric acid, if necessary, to bring pH to about 6.8.

A representative formulation of a generally transparent soap product in accordance with an exemplary embodiment of the present invention may include the following to produce approximately 260 gallons (˜2172 lbs.) of soap: 1,724.10 lbs. water; 390.9 lbs. surfactant blend; 10.8 lbs. Mackernium-007; 13 lbs. Glydent; 10.8 lbs. sodium chloride; 5.4 lbs. AFF#24465; 2.8 lbs. tetrasodium EDTA; 0.6 lbs. citric acid; and 10.8 lbs. microencapsulated colorant beads. Such a formulation may be realized in accordance with the representative manufacturing procedure substantially similar to that describe vide supra.

Individual components of the invention may include base liquid soap, encapsulated FDA approved dyes, Primasponges, etc. in water insoluble/dispersible and/or soluble in organic phase solvents and/or suspended in an agent, such as xanthan gum for example.

In various alternative exemplary embodiments, other encapsulated materials may be employed, such as, for example: fragrances; anosmics; deodorants; lubricants; lotions; chemically active compounds; medicinal preparations; pharmaceuticals; bio-active compounds; nutrients; vitamins; and/or any other material or composition of matter, whether now known, hereafter discovered or otherwise described in the art.

Various physical microencapsulation techniques may be employed, such as, for example: spray drying; spray chilling; rotary disk atomization; fluid bed coating; stationary nozzle coextrusion; centrifugal head coextrusion; submerged nozzle coextrusion; pan coating; and/or the like. Various chemical microencapsulation techniques may be alternatively, conjunctively and/or sequentially employed, such as, for example: phase separation; solvent evaporation; solvent extraction; interfacial polymerization; simple and complex coacervation; in-situ polymerization; liposome technology; nanoencapsulation; and/or the like.

Some examples of various microencapsulation “shell” materials may include, for example: proteins (e.g., gelatin, casein, zein, soy, albumin, etc.); polysaccharides (e.g., hydrocolloids, starch, algin/alginate, agar/agarose, pectin/polypectate, carrageenan, various gums, etc.); waxes (e.g., hydrophilic waxes, lipophilic waxes, shellac, polyethylene glycol, carnauba wax, beeswax, etc.); fats and fatty acids (e.g., mono-, di- and triglycerides, lauric acid, capric acid, palmitic acid, stearic acid, various acid salts, etc.); cellulosic derivatives (e.g., methyl-, ethyl-cellulose, CMC, etc.); natural polymers; synthetic polymers; resins; sugar derivatives; and/or the like.

Various analytical methods may be employed to monitor or otherwise assist the microencapsulation of materials in accordance with exemplary embodiments of the present invention, including, for example: particle size analysis; optical microscopy; electron microscopy; dissolution testing; hardness testing; viscometry; D'Nouy ring tensiometry; Wilhelmy plate tensiometry; Fourier transform infrared spectroscopy (FT-IR); nuclear magnetic resonance spectroscopy (NMR); high-performance liquid chromatography (HPLC); differential scanning calorimetry (DSC); thermogravimetric analysis (TGA); gas chromatography (GC); mass spectrometry (MS); ultraviolet-visible spectrophotometry (UV-VIS); and/or the like.

Various parameters of the microencapsulation may be altered to suitably adjust or otherwise configure: controlled release; sustained release; delayed release; targeted release; thermal release; pressure release; photolytic release; osmotic release; pH-induced release; and/or the like.

Various microencapsulation processes allow product formulators to make capsules from less than a micrometer to several thousand micrometers in size. Each process offers specific attributes, such as high production rates, large production volumes, high production yields, and different capital and operating costs. Other process variables include greater flexibility in shell material selection and differences in microcapsule morphology, particle size and distribution.

Microencapsulation processes include both physical and chemical techniques as described vide supra. Physical methods generally use commercially available equipment to create and stabilize the capsules. Chemical techniques generally apply ionic chemistry to create microspheres in batch reactors. Of the physical techniques, the spray-drying process typically uses a two-nozzle (internal or external mix) assembly, allowing air from an annular geometry to atomize and implode the issuing liquid stream to form fine particles carrying the microencapsulated product in a dispersed state. With high particle-specific surface areas, heat from the drying chamber flash-evaporates the solvent or aqueous media, rendering powder microcapsules cyclone-collected into a holding chamber. Some spray-drying operations use rotary atomizers that spin at up to 50,000 rpm.

Other physical techniques include the spinning disc and coextrusion processes. The spinning disc method, similar to the spray-drying process, uses an emulsion or suspension containing the encapsulation product, prepared with a solution or melt of the coating material. The emulsion or suspension is fed to the disc surface and forms a thin wetted layer that, as the disc rotates, breaks up into airborne droplets from the surface tension forces that induce thermodynamic instabilities. Resulting capsules are typically spherical. Because the emulsion or suspension is not extruded through orifices, this technique permits use of a generally higher viscosity shell material and allows higher loading of the encapsulation product in the shell. The process also offers a broad range of particle sizes with a controlled distribution. Coextrusion encapsulation methods, developed at Southwest Research Institute (SwRI), San Antonio, may be adapted to create fibers containing the encapsulation product within fluid, high-viscosity, glassy sugars and carbohydrates. These fibers may then be chopped to create microcylinders. When the viscosity is low and the surface tension of the fluid is high, such extrudates would generally thermodynamically break up into tiny droplets, creating microcapsules.

A typical extrusion system utilizes a stationary nozzle coextrusion, centrifugal coextrusion, or submerged nozzle coextrusion. All these processes involve concentric nozzles, which pump the core material through the inner nozzle while the shell formulation is pumped through the annulus, allowing true “core-shell” morphologies, unlike the previously described processes.

As the liquid stream exits the nozzle, local disturbances, such as induced vibration or gravitational, centrifugal, or drag force may generally be affected to control or otherwise parameterize particle size. Typical microcapsules produced by coextrusion range from 100 micrometers to 6 mm, or about the size of a human egg cell to the size of a pencil eraser.

Encapsulated colorant, dye and/or indicator material may be carried inside the microencapsulated beads with a hydrophilic solution, hydrophobic solution, surfactant solution, and/or the like. For example, shea butter, cocoa butter and/or the like may be used as a carrier for the colorant in order to provide an emollient effect upon rupture of the beads. In a representative exemplary application, a soap (or other at least partially saponified triglyceride, oil or fat) may be used as an encapsulated colorant and/or fragrance carrier, for example, to enhance or otherwise optimize the lather characteristics upon rupture of the beads and/or dispersal of the colorant/indicator/fragrance material and soap carrier therein.

In another representative and exemplary embodiment of the present invention, the colorant/indicator/fragrance/active particles may be delivered in a foaming handwash formulation that utilizes at least one optionally partitioned chamber to at least partially foam the handwash soap composition prior to or during dispensing. The particles may be contemporaneously mixed with or otherwise introduced to the foam lather prior to or during dispensing of the handwash composition. This may be accomplished, for example, by introducing air with a pump dispenser into the dispensing vessel or other at least partially partitioned cavity of the dispensing vessel.

In the foregoing specification, the invention has been described with reference to specific exemplary embodiments; however, it will be appreciated that various modifications and changes may be made without departing from the scope of the present invention as set forth in the claims. The specification is to be regarded in an illustrative manner, rather than a restrictive one and all such modifications are intended to be included within the scope of the present invention. Accordingly, the scope of the invention should be determined by the claims and their legal equivalents. For example, the steps recited in any method or process embodiments may be executed in any order and are not limited to the specific order presented in the claims. Additionally, the components and/or elements recited in any apparatus embodiment may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, “having” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A cleansing composition, said composition comprising:
a surfactant, said surfactant suitably adapted to produce a lather upon application of mechanical forces to said surfactant;
a colorant, said colorant substantially segregated from the surfactant such that said colorant comprises at least a plurality of discrete particles;
said colorant particles optionally mixed with the surfactant prior to dispensing from a containment vessel for subsequent use;
said colorant particles suitably adapted to change the color of the surfactant lather after a substantially predetermined period of time during which mechanical forces are applied to said colorant particles and said surfactant.

2. The cleansing composition of claim 1, wherein said surfactant comprises at least one of soap and an at least partially saponified triglyceride.

3. The cleansing composition of claim 2, wherein said composition comprises a handwash.

4. The cleansing composition of claim 1, wherein said colorant comprises at least one of a dye, a non-colorfast dye, an indicator, and a pH indicator.

5. The cleansing composition of claim 1, further comprising an indicator substantially segregated from said colorant particles.

6. The cleansing composition of claim 5, wherein said indicator is substantially mixed with said surfactant and said colorant comprises a material suitably adapted to affect a substantial color change upon exposure to said indicator.

7. The cleansing composition of claim 6, wherein said indicator comprises a pH indicator.

8. The cleansing composition of claim 7, wherein said pH indicator comprises phenolphthalein and said colorant comprises a weakly alkaline solution.

9. The cleansing composition of claim 1, wherein said colorant particles comprise at least one of substantially homogenous beads, substantially inhomogeneous beads, encapsulated beads, and microencapsulated beads.

10. The cleansing composition of claim 9, wherein said beads range in diameter from about 100 micrometers to about 6 millimeters.

11. The cleansing composition of claim 10, wherein said beads comprise at least one of protein, gelatin, casein, zein, soy, albumin, polysaccharides, hydrocolloids, starch, algin/alginate, agar/agarose, pectin/polypectate, carrageenan, gums, waxes, hydrophilic waxes, lipophilic waxes, shellac, polyethylene glycol, carnauba wax, beeswax, triglycerides, fats, fatty acids, salts of fatty acids, mono-triglycerides, di-triglycerides, lauric acid, capric acid, palmitic acid, stearic acid, cellulosic derivatives, methyl-cellulose, ethyl-cellulose, CMC, natural polymers, synthetic polymers, resins, sugars, and sugar derivatives.

12. A cleansing composition, said composition comprising:
a surfactant, said surfactant suitably adapted to produce a lather upon application of mechanical forces to said surfactant;
a carried material, said carried material substantially segregated from the surfactant such that said carried material comprises at least a plurality of discrete particles;
said particles optionally mixed with the surfactant prior to dispensing from a containment vessel for subsequent use;
said particles suitably adapted to change at least one physical property of the surfactant lather after a substantially predetermined period of time during which mechanical forces are applied to said particles and said surfactant.

13. The cleansing composition of claim 12, wherein said surfactant comprises at least one of soap and an at least partially saponified triglyceride.

14. The cleansing composition of claim 13, wherein said composition comprises a handwash.

15. The cleansing composition of claim 12, wherein said carried material comprises at least one of a fragrance, an anosmic, a deodorant, a lubricant, an emollient, a chemically active compound, a medicinal material, a pharmaceutical preparation, a bio-active compound, a nutrient, and a vitamin.

16. The cleansing composition of claim 12, wherein said particles comprise at least one of substantially homogenous beads, substantially inhomogeneous beads, encapsulated beads, and microencapsulated beads.

17. The cleansing composition of claim 16, wherein said beads range in diameter from about 100 micrometers to about 6 millimeters.

18. The cleansing composition of claim 12, wherein said beads comprise at least one of protein, gelatin, casein, zein, soy, albumin, polysaccharides, hydrocolloids, starch, algin/alginate, agar/agarose, pectin/polypectate, carrageenan, gums, waxes, hydrophilic waxes, lipophilic waxes, shellac, polyethylene glycol, carnauba wax, beeswax, triglycerides, fats, fatty acids, salts of fatty acids, mono-triglycerides, di-triglycerides, lauric acid, capric acid, palmitic acid, stearic acid, cellulosic derivatives, methyl-cellulose, ethyl-cellulose, CMC, natural polymers, synthetic polymers, resins, sugars, and sugar derivatives.

19. A method of providing a cleansing composition, said method comprising the steps of:
providing a surfactant, said surfactant suitably adapted to produce a lather upon application of mechanical forces to said surfactant;
providing a carried material, said carried material substantially segregated from the surfactant such that said carried material comprises at least a plurality of discrete particles;
optionally mixing said particles with the surfactant prior to dispensing from a containment vessel for subsequent use;
said particles suitably adapted to change at least one physical property of the surfactant lather after a substantially predetermined period of time during which mechanical forces are applied to said particles and said surfactant.

20. The method of claim 19, wherein said carried material comprises at least one of a colorant, an indicator, a pH indicator, a weakly alkaline solution, a weakly acidic solution, a fragrance, an anosmic, a deodorant, a lubricant, an emollient, a chemically active compound, a medicinal material, a pharmaceutical preparation, a bio-active compound, a nutrient, a vitamin, and a first material suitably adapted to affect change of a physical property of said surfactant lather upon exposure of said first material to a second material in said surfactant wherein said exposure comprises at least partial rupture of said particle in response to said application of mechanical forces.
